(19) United States
(12) Patent Application Publication
(10) Pub. No.: US 2015/0175414 A1
(43) Pub. Date: Jun. 25, 2015

(54) CO-CONVERSION OF CARBONACEOUS MATERIAL AND BIOMASS

(71) Applicant: Suresh P. Babu, Willow Springs, IL (US)

(72) Inventor: Suresh P. Babu, Willow Springs, IL (US)

(21) Appl. No.: 14/565,698

(22) Filed: Dec. 10, 2014

Related U.S. Application Data
(60) Provisional application No. 61/920,535, filed on Dec. 24, 2013.

(51) Int. Cl. C01B 3/02; C01B 31/20; C10J 3/46

(52) U.S. Cl. CPC C01B 3/02; C10J 3/463; C01B 31/20; C10J 2200/06

(57) ABSTRACT

A method for producing a product includes providing a first feed including a biomass into a reactor, providing a second feed including a carbonaceous material into the reactor, and providing a third feed including carbon dioxide into the reactor. The first feed, the second feed, and the third feed react in the reactor with reaction conditions sufficient to: a) gasify the biomass, b) dry reform the carbonaceous materials with the carbon dioxide, and c) produce the product. A conversion system and a reactor are also provided.

### CROSS-REFERENCE TO RELATED APPLICATIONS

This application claims the benefit of U.S. Provisional Application Ser. No. 61/920,535, filed Dec. 24, 2013, which is incorporated by reference.

### STATEMENT REGARDING FEDERALLY SPONSORED RESEARCH OR DEVELOPMENT

This invention was made with Government support under Contract No. DE-AC02-98CH 10886 awarded by the Department of Energy. The Government has certain rights in this invention.

### FIELD OF THE INVENTION

This application relates to co-conversion of carbonaceous material and biomass within a single reactor or reactor vessel to a produce synthesis gas product for conversion to liquid fuels and/or chemicals.

### BACKGROUND

Steam reforming is a process which reacts steam at high temperature with hydrocarbon fuels in a reformer to produce hydrogen. Dry reforming is a process which produces hydrogen and carbon monoxide from the reaction of carbon dioxide with hydrocarbons. Gasification is a process which typically utilizes a separate reactor to convert carbonaceous materials into carbon monoxide, hydrogen, and carbon dioxide at high temperatures with steam and either with an oxidant for direct heating or by indirect heat supply. However, systems and methods are lacking to combine these processes in such a way so as to allow for efficient production of fuels and chemicals from biomass with a minimal carbon footprint.

### SUMMARY

According to one aspect, a method for producing a product includes providing a first feed into a reactor, the first feed comprising a biomass, providing a second feed into the reactor, the second feed comprising a carbonaceous material, providing a third feed into the reactor, the third feed comprising carbon dioxide, and reacting the first feed, the second feed, and the third feed in the reactor with reaction conditions sufficient to: a) gasify the biomass, b) dry reform the carbonaceous materials with the carbon dioxide, and c) produce the product.

According to another aspect, a conversion system adapted to produce a synthesis gas is provided. The system includes a reactor having a housing, a first source for delivering a biomass, a second source for delivering a carbonaceous material, a third source for delivering carbon dioxide, and a fluidized bed including fluidizing solids. The fluidized bed and the housing are adapted to react a delivered biomass, a delivered carbonaceous material, and delivered carbon dioxide under reaction conditions sufficient to gasify the biomass, to dry reform the carbonaceous material with the carbon dioxide, and to produce a synthesis gas product.

According to yet another aspect, a reactor includes a housing, a first feed port adapted to receive a biomass, a second feed port adapted to separately receive carbonaceous material and carbon dioxide, and a fluidized bed including fluidizing solids. The reactor contains gasified biomass, carbonaceous material dry reformed with carbon dioxide, fluidizing solids and a synthesis gas.

### BRIEF DESCRIPTION OF THE FIGURES

FIG. 1 illustrates an example system that can be utilized to co-convert carbonaceous material, biomass, and carbon dioxide;

FIG. 2 illustrates an example system that can be utilized to co-convert carbonaceous material, biomass, and carbon dioxide to produce synthesis gas for subsequent conversion to liquid fuels and/or chemicals; and

FIG. 3 illustrates a flow diagram of an example process for co-conversion of carbonaceous material, biomass, and carbon dioxide.

### DETAILED DESCRIPTION

In some examples, methods for producing a product are generally described. The methods may include first receiving a carbonaceous feed (first feed) into a reactor. The first feed may include a biomass. The disclosed methods may include receiving a second feed in the same reactor. The second feed may include one or more carbonaceous materials. The methods may include receiving a third feed into the same reactor. The third feed may include carbon dioxide. The methods may include reacting the first, second, and third feeds in the reactor with reaction conditions sufficient to gasify the biomass, dry reform the carbonaceous material with the carbon dioxide, and produce a synthesis gas product.

Herein, a conversion system adapted to produce a product is generally described. The system may include a reactor. The reactor may include a housing. The reactor may include a first feed configured to receive a biomass, a second feed configured to receive carbonaceous materials, and/or a third feed configured to receive carbon dioxide. In one embodiment, the reactor includes a fluidized bed including fluidizing solids. The fluidized bed and the housing may be configured to react the first, second and third feed with reaction conditions sufficient to gasify the biomass, to dry reform the carbonaceous material with carbon dioxide, and to produce a synthesis gas product.

In some examples, a reactor adapted to produce a product is generally described. In one embodiment, the reactor includes a housing, a first feed to provide biomass, a second feed to deliver carbonaceous materials, and a third feed to provide carbon dioxide. The reactor may further include a fluidized bed including fluidizing solids. The reactor may also include gasified biomass and carbonaceous material dry reformed with the carbon dioxide.

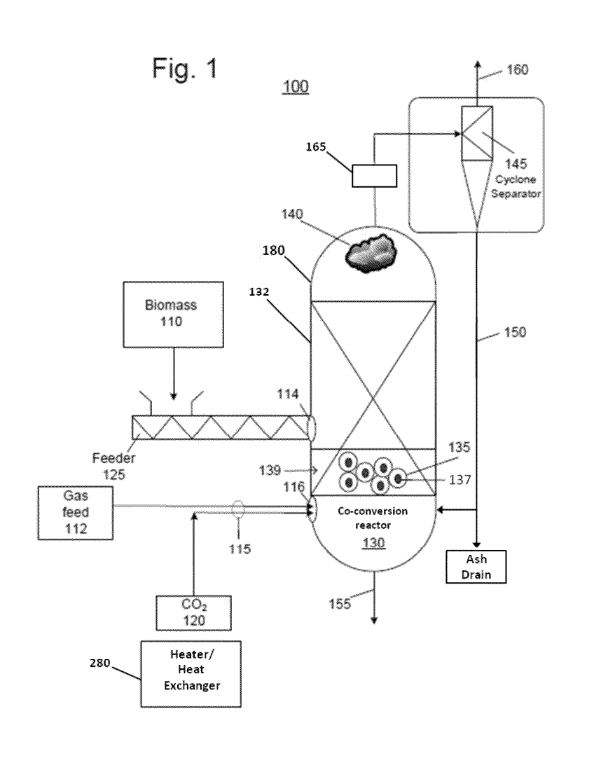

In the following detailed description, reference is made to the accompanying FIGS. 1-3, in which identical reference numbers identify the same or similar components unless context dictates otherwise. In FIG. 1, an example system 100 is illustrated that can be utilized to co-convert carbonaceous materials, biomass, and carbon dioxide, arranged in accordance with at least some embodiments presented herein. As discussed in more detail below, co-conversion, including carbonaceous material dry reformation and biomass gasification, may occur within a reactor. In one embodiment, the system 100 includes a co-conversion reactor 130 including a housing 132. The co-conversion reactor 130 may receive biomass 110 from a feeder system 125 at a feed port 114 in the housing 132. Contemplated biomass 110 may include, without limitation, biological material from living or recently living organisms such as lignocellulosic biomass derived from plants, recycled biomass materials, and/or waste biomass sources. For example, the biomass 110 may be wood waste, bark, straw, wood chips, rice husks, corn stover, wood pellets, distillers grain, lignocellulosic biomass or cellulosic fraction derived from municipal solid waste (MSW) or refuse-derived fuel (RDF), for example. The biomass 110 may also include dried biomass and have approximately 10% water content. The feeder system 125 may include a screw, a plug, a ram, a pneumatic, and/or a vibration feeder system or other suitable feeder system, and combinations thereof capable of delivering the biomass 110 to the co-conversion reactor 130.

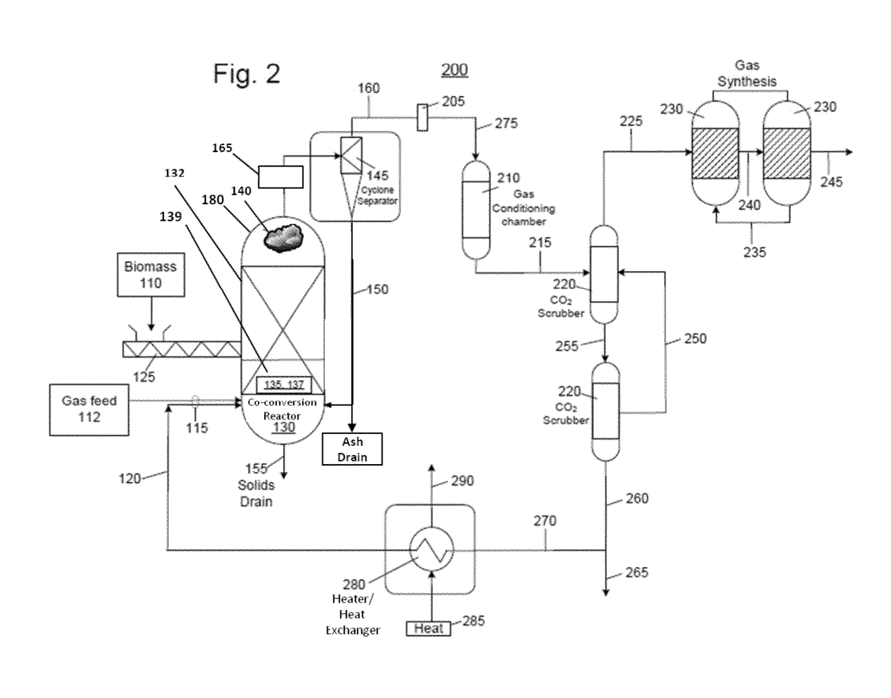

A gas feed 112 and a carbon dioxide (CO₂) stream 120 may also feed into the co-conversion reactor 130 at a second feed port 116. The gas feed 112 and the carbon dioxide feed 120 may be combined prior to feeding into the co-conversion reactor 130 as a mixed feed 115, or the gas feed 112 and the carbon dioxide feed 120 may feed into the co-conversion reactor 130 independently. In some examples, the carbon dioxide feed 120 may further include additional oxidants such as air, enriched air, or steam, for example. Additional oxidants may be added to maintain gas velocity and to maintain uniform temperature conditions. The gas feed 112 may include carbonaceous materials, such as a gas including methane (CH₄). The gas feed 112 may include natural gas, shale gas, or any other suitable methane-including gases including methane recovered from landfills, or methane hydrates. In one embodiment, the carbon dioxide feed 120 is heated by a heater/heat exchanger 280 or separate heater 285 (see FIG. 2) to a temperature in a range of 850° C. to 1200° C., such as 1100 ° C. In other embodiments, the carbon dioxide feed 120 is heated to a suitable temperature.

The co-conversion reactor 130 may be a fluidized reactor and may include a fluidized bed 139. The fluidized bed 139 may include fluidizing solids 135 that are effective or adapted to maintain a bubbling fluidized bed that includes biomass 110 within the co-conversion reactor 130. The fluidized bed 139 may also facilitate dry-reformation of the gas feed 112 with the carbon dioxide feed 120. Fluidizing solids 135 may move at a velocity above the minimum fluidization velocity to provide bubbling fluidized solids.

The fluidizing solids 135 may be made of or include a material that is robust and may minimize or fully resist abrasion, such as solids with a spherical shape. The fluidizing solids 135 may be made from naturally occurring minerals, for example alumina. The fluidizing solids 135 may be spherical solids, 1 millimeter (mm) to 2 mm in diameter in certain embodiments, although in other embodiments the spherical fluidizing solids may have a different suitable diameter range. The fluidizing solids 135 may be doped with one or more catalysts 137. The catalyst 137 may be a reformation catalytic material such as NiO, CoO, TiO₂, CeO₂, mixed NiO—CoO, (Ni, CO)O/MgO, for example, or combinations thereof. One example of a catalyst 137 may include a MgO—ZrO₂ mesoporous support (Zr/Mg molar ratio=9) impregnated with 6 wt % Ni, 6 wt % Co, and 3 wt % of both Ni and Co. Other suitable catalysts may be Ni/γAl₂O₃, Ni/MgO-γ-Al₂O₃, Ni/MgAl₂O₄, high surface area ceria (CeO₂ (HSA)), MoO₃, Mo₂C, Ni/La₂O₃, potassium enhanced Ni/MgO, Ni supported on γAl₂O₃, CeO₂, ZrO₂, and MgAl₂O₄, and high surface area molybdenum and tungsten carbide materials.

The catalyst 137 may promote surface reactivity to reform methane in the gas feed 112 and facilitate retention of the biomass 110 in the reactor 130 for conversion to gasification products. The catalyst 137 may promote rapid production of a synthesis gas 140 with high selectivity to carbon monoxide (CO) and hydrogen (H₂). The catalyst 137 may promote a desired molar ratio of carbon monoxide (CO) and hydrogen (H₂) based on conversion of a synthesis gas 140 to a fuel and/or a chemical.

In one example, a biomass 110 may have a composition of 50% carbon, 6% hydrogen, and 44% oxygen on a dry, ash-free basis. The biomass 110 may undergo gasification in the co-conversion reactor 130. In another example, the biomass 110 may be represented by the chemical formula CH_{1.44}O_{0.66}. The gas feed 112 may undergo a dry reformation in the co-conversion reactor 130. The gas feed 112 may primarily include methane gas represented by the chemical formula CH₄. The carbon dioxide feed 120 may be mostly carbon dioxide and represented by the chemical formula CO₂. The overall chemical reaction in the co-conversion reactor 130 may be represented by:

CH_{1.44}O_{0.66}+CH4+CO2 [symbol] 3CO+2.72H2

The chemical reaction in the co-conversion reactor 130 may be endothermic in the forward direction and may require heat to sustain. Heated carbon dioxide in the carbon dioxide feed 120 may provide sufficient endothermic energy to sustain the forward reaction. The co-conversion reactor 130 may have an internal reaction pressure of 20 psi or above to transport product gases through process vessels in certain embodiments.

In another example, reactions may take place within the co-conversion reactor 130 at 1100° C. at a low pressure capable of pushing the product gases through the co-conversion reactor 130. Oxidants may be included in the co-conversion reactor 130 to facilitate the co-conversion process. Vapor pressure from steam produced from water content of the biomass 110 within the co-conversion reactor 130 may prevent carbon formation in the co-conversion reactor 130 and supplement synthesis gas production by promoting in-situ water-gas shift reactions.

The co-conversion reactor 130 may facilitate dry reforming of methane in the gas feed 112 and gasification of the biomass 110. The co-conversion reactor 130 may produce synthesis gas 140. Synthesis gas 140 may include carbon monoxide, hydrogen, carbon dioxide, and steam, for example. Ash and solids produced during gasification of the biomass 110 in the co-conversion reactor 130 may defluidize the co-conversion reactor 130 and may be removed as dry ash or heavy agglomerates through a solids drain 155.

Synthesis gas 140 produced by the co-conversion reactor 130 may be partially cooled in a heat exchanger 165 to ensure that the alkalis from the biomass 110 will be deposited on entrained particulate matter. The partially cooled gases may be sent to a cyclone separator 145. The cyclone separator 145 may remove dense entrained solid particulates in the synthesis gas 140 to produce post cyclone (or refined) synthesis gas 160. Entrained particulate matter 150, removed from the synthesis gas 140, may be reprocessed or drained from the system 100. Post cyclone synthesis gas 160 may undergo further processing for conversion to fuels and chemicals, as desired. The carbon dioxide in the post cyclone synthesis gas 160 may be removed and may be recycled to the carbon dioxide feed 120 as described in system 200.

FIG. 2 illustrates another example system 200 that can be utilized to co-convert carbonaceous material, biomass, and carbon dioxide to produce synthesis gas for subsequent conversion to liquid fuels and/or chemicals. The system 200 depicted in FIG. 2 is substantially similar to system 100 of FIG. 1, with additional details. Those components in FIG. 2 that are labeled identically to components of FIG. 1 will not be described again for the purposes of clarity.

Post cyclone synthesis gas 160 may pass through a barrier filter 205 to produce a filtered synthesis gas 275. The barrier filter 205 may remove particulates that were not previously removed by the cyclone separator 145. Particulates removed by the barrier filter 205 may include alkali compounds inherent in the biomass 110. Filtered synthesis gas 275 may undergo further processing for conversion to fuels and chemicals.

The filtered synthesis gas 275 may be further processed by a gas conditioning reactor 210. The gas conditioning reactor 210 may facilitate a water-gas shift reaction, such as CO_{(g)}+H₂O(g)→CO₂(g)+H₂(g), on carbon monoxide and water in the filtered synthesis gas 275. The water-gas shift reaction may adjust the H₂/CO ratio from approximately 0.7 to approximately 2.0. The water-gas shift reaction may take place in the gas conditioning reactor 210 in multiple stages including a high temperature shift followed by a low temperature shift. The high temperature shift and the low temperature shift may be separated by intersystem cooling and may be facilitated with different catalysts. For example, a high temperature shift reaction may use catalysts including Fe₂O₃, Cr₂O₃, and MgO. A low temperature shift reaction may use catalysts including CuO, ZnO, and Al₂O₃.

The gas conditioning reactor 210 may produce a conditioned synthesis gas 215. The conditioned synthesis gas 215 may include carbon monoxide (CO), hydrogen (H₂), and carbon dioxide (CO₂). The conditioned synthesis gas 215 may be further processed by carbon dioxide (CO₂) scrubbers 220 to separate carbon dioxide gas 260 and a scrubbed synthesis gas 225. Carbon dioxide in the conditioned synthesis gas 215, in a scrubber recycle gas 250, and in a scrubber intermediary gas 255 may be absorbed into a scrubber solution, and released in a vessel within the carbon dioxide scrubbers 220 to produce a carbon dioxide gas stream 260. The scrubbed synthesis gas 225 may include carbon monoxide (CO), carbon dioxide (CO₂) and hydrogen (H₂) with carbon dioxide (CO₂) quantities reduced from the conditioned synthesis gas 215

In one embodiment, the carbon dioxide scrubbers 220 are operatively coupled in series. Carbon dioxide removed from the conditioned synthesis gas 215 may be used in the shale gas process. Carbon dioxide gas 260 may also be recycled into recycled carbon dioxide gas 270. Surplus carbon dioxide 265 may be used in the shale fracturing gas recovery process to conserve conventional fracture fluids or may be sequestered in underground saline aquifers. Carbon dioxide may also be recycled into recycled carbon dioxide gas 270.

The recycled carbon dioxide gas 270 may be heated by a heater/heat exchanger 280. The heat exchanger 280 may heat recycled carbon dioxide gas 270 with heat from a separate heat source, such as heater 285. The heater/heat exchanger 280 may heat recycled carbon dioxide gas 270 with heat recovered from the exothermic heat generated from gas synthesis gas reactors 230, as discussed below. The heater/heat exchanger 280 may heat recycled carbon dioxide gas 270 by combustion of any unconverted process derived gases from gas synthesis gas reactors 230 or by burning shale gas in heater 280. The resulting flue gases 290 are vented after heat recovery. The carbon dioxide feed 120 may be fed with heated carbon dioxide from the recycled carbon dioxide gas 270.

The scrubbed synthesis gas 225, after removal of at least some carbon dioxide by the carbon dioxide scrubbers 220, may be further processed by the gas synthesis reactors 230. The gas synthesis reactors 230 may produce a gas synthesis intermediary gas 240 and a gas synthesis recycle gas 235. The gas synthesis reactors 230 may produce synthesized products 245 from the scrubbed synthesis gas 225, such as a liquid hydrocarbon via the Fischer-Tropsch process. Additional liquid fuel synthesis processes are contemplated herein as are known in the art, such as to produce mixed alcohols or dimethyl ether (DME), among others. The Fischer-Tropsch process may be highly exothermic and may require removal of heat from the gas synthesis reactor 230. The heat of reaction may be utilized by the heater/heat exchanger 280 to heat the recycled carbon dioxide gas 270.

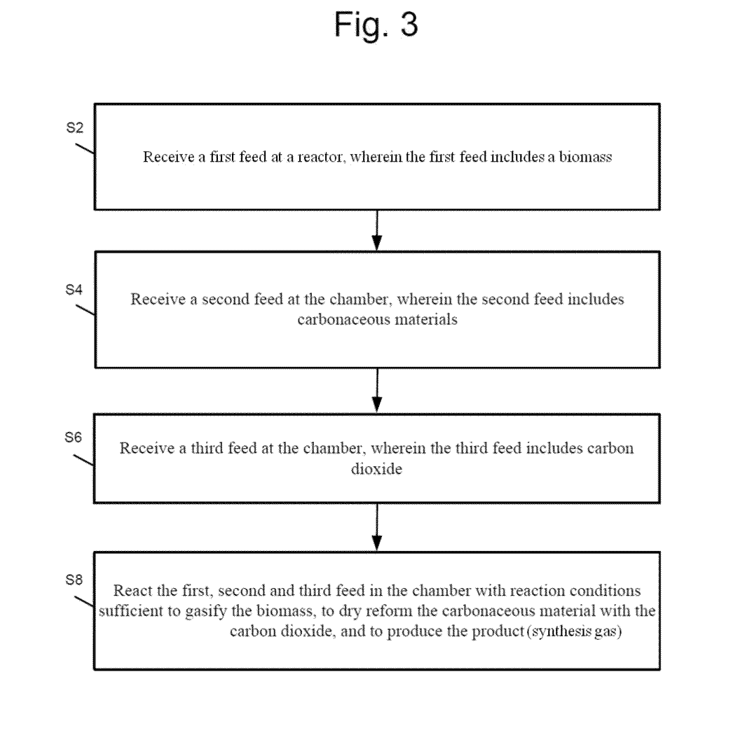

FIG. 3 illustrates a flow diagram of an example process 300 for co-conversion of carbonaceous material, biomass, and carbon dioxide, arranged in accordance with at least some embodiments presented herein. The process of FIG. 3 may be implemented using, for example, the system 100 or the system 200 discussed above and may be used to co-convert carbonaceous material, biomass, and carbon dioxide, as discussed herein. An example process may include one or more operations, actions, or functions as illustrated by one or more of blocks S2, S4, S6, and/or S8. Although illustrated as discrete blocks, various blocks may be divided into additional blocks, combined into fewer blocks, or eliminated, depending on the desired implementation.

In certain embodiments, processing may begin at block S2, where a reactor may receive a first feed including biomass. The biomass may be lignocellulosic biomass derived from plants. For example, the biomass may be wood waste, bark, straw, wood chips, rice husks, corn stover, wood pellets, distillers grain, or cellulosic wastes derived from MSW or RDF, for example. The biomass may be dried biomass and have approximately 10% water content. A feeder may deliver the biomass to the reactor. The feeder may be a screw, plug, ram, pneumatic, vibration, and/or any other suitable feeder system capable of delivering the biomass.

Processing may continue from block S2 to block S4, where the reactor may receive a second feed including a carbonaceous material. The carbonaceous material may be natural gas, shale gas, or any other methane-including gases including methane recovered from landfills, biomass, or methane hydrates.

Processing may continue from block S4 to block S6, where the reactor may receive a third feed including carbon dioxide. The carbon dioxide may be heated by a heater. In one embodiment, the carbon dioxide is heated to 1100° C.

Processing may continue from block S6 to block S8, where the first, second, and third feeds may react within the reactor. The biomass may gasify and the carbonaceous material may dry reform with the carbon dioxide to produce a product. The reaction in the reactor may be endothermic in the forward direction and may require heat to sustain the reaction. Heated carbon dioxide in the third feed may provide endothermic energy to sustain the forward reaction. The reaction may take place within the reactor at 1100° C. and at a low pressure. The pressure within the reactor may be 20 psi to 100 psi.

The product produced may be hydrogen and carbon monoxide. The hydrogen and carbon monoxide may be further processed for conversion to fuels and chemicals, including, without limitation, chemical intermediates. Such chemical intermediates would then be produced with 100% indigenous resources. Carbon dioxide may also be produced. Some of the carbon dioxide produced may be recycled to the third feed.

Among other possible benefits, a system in accordance with the present disclosure may be able to convert carbonaceous material to synthesis gas and biomass to biomass products within one reactor. In other words, a co-conversion may take place within a single reactor in which case dry reformation and gasification are not independent of each other nor are they conducted in parallel to produce the product. The blending of carbonaceous material and biomass may improve the scale of the biomass operation. Integrating dry reformation of carbonaceous material and gasification of biomass may synergistically co-convert within a co-conversion reactor as biomass gasification produces steam that may be used to prevent carbon formation during dry reformation.

Another benefit of the present system may be to promote building a robust biomass feedstock supply infrastructure co-existing with shale gas resources; thus, providing a method for biomass to compete with other fuel sources. Increased biomass operations may lessen the carbon footprint of the fuel produced. Furthermore, since the present system is operated at the dry reformation temperature of 1100° C., a temperature that is higher than the gasification temperature of about 850° C., both the higher temperature and the presence of reducing reformation products will minimize or eliminate condensable hydrocarbon formation during biomass gasification.

A further benefit of the present system may be to minimize or eliminate the use of air or enriched air within the co-conversion reactor. A consequence of minimizing air may lead to an absence of flame in the reactor yielding a more uniform operating temperature and stable reactor operation. By dry reforming and avoiding the addition of steam, the system may also reduce the water footprint of the process. Operation at a relatively low pressure may simplify reactor design and avoid the need for advanced or expensive high pressure biomass feeders or expensive materials of the reactor construction. A system in accordance with the present disclosure may recover most if not all alkali compounds inherent in the biomass along with the ash discharged from the co-conversion reactor. Surplus carbon dioxide may be produced and can be used for shale fracture thereby reducing the amount of water and chemicals used for shale fracture.

It will be understood that any compound, material or substance which is expressly or implicitly disclosed in the specification and/or recited in a claim as belonging to a group or structurally, compositionally and/or functionally related compounds, materials or substances, includes individual representatives of the group and all combinations thereof.

While various aspects and embodiments have been disclosed herein, other aspects and embodiments will be apparent to those skilled in the art. The various aspects and embodiments disclosed herein are for purposes of illustration and are not intended to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

INDUSTRIAL APPLICATION

The systems and methods disclosed herein allow for efficient production of fuels and chemicals from biomass with a minimal carbon footprint.

The disclosure has been presented in an illustrative manner in order to enable a person of ordinary skill in the art to make and use the disclosed system and methods, and the terminology used is intended to be in the nature of description rather than of limitation. It is understood that the disclosure may be practiced in ways other than as specifically disclosed, and that all modifications, equivalents, and variations of the present disclosure, which are possible in light of the above teachings and ascertainable to a person of ordinary skill in the art, are specifically included within the scope of the impending claims.

What is claimed is:

1. A method for producing a product, the method comprising:
providing a first feed into a reactor, the first feed comprising a biomass;
providing a second feed into the reactor, the second feed comprising a carbonaceous material;
providing a third feed into the reactor, the third feed comprising carbon dioxide; and
reacting the first feed, the second feed, and the third feed in the reactor with reaction conditions sufficient to:
a) gasify the biomass,
b) dry reform the carbonaceous materials with the carbon dioxide, and
c) produce the product.

2. The method of claim 1, wherein the reactor comprises a single fluidized bed comprising fluidizing solids in an amount to maintain a bubbling fluidized bed.

3. The method of claim 2, wherein the fluidizing solids are doped with a catalyst.

4. The method of claim 3, wherein the catalyst comprises a reformation catalytic material.

5. The method of claim 4, wherein the reformation catalytic material is selected from the group consisting of NiO, CoO, TiO₂, CeO₂, mixed NiO-CoO, (Ni, CO)O/MgO, Al₂O₃, and combinations thereof.

6. The method of claim 1, wherein the biomass comprises a lignocellulosic biomass comprising at least one selected from the group consisting of wood waste, bark, straw, wood chips, rice husks, corn stover, wood pellets, distillers grain, cellulosic fraction of municipal solid waste (MSW) and refuse-derived fuel (RDF).

7. The method of claim 1, wherein the second feed comprises at least one selected from the group consisting of natural gas, shale gas, and methane.

8. The method of claim 1, wherein the third feed comprises carbon dioxide at a temperature of 1100° C.

9. The method of claim 1, wherein the product comprises at least one of a synthesis gas and surplus CO₂ for use in shale fracturing.

10. A conversion system adapted to produce a synthesis gas, the conversion system comprising:
a reactor, the reactor comprising:
a housing;
a first source for delivering a biomass;
a second source for delivering a carbonaceous material;
a third source for delivering a carbon dioxide; and
a fluidized bed comprising fluidizing solids,
wherein the fluidized bed and the housing are adapted to react a delivered biomass, a delivered carbonaceous material, and delivered carbon dioxide under reaction conditions sufficient to gasify the biomass, to dry reform the carbonaceous material with the carbon dioxide, and to produce a synthesis gas product.

11. The conversion system of claim 10, wherein the fluidizing solid in the fluidized bed is effective to maintain a bubbling fluidized bed.

12. The conversion system of claim 11, wherein the fluidizing solid is doped with a catalyst.

13. The conversion system of claim 12, wherein the catalyst is a reformation catalytic material.

14. The conversion system of claim 13, wherein the reformation catalytic material is selected from the group consisting of NiO, CoO, TiO₂, CeO₂, mixed NiO-CoO, (Ni, CO)O/MgO, and combinations thereof.

15. The conversion system of claim 10, wherein the biomass is a lignocellulosic biomass selected from the group consisting of wood waste, bark, straw, wood chips, rice husks, corn stover, wood pellets, distillers grain, cellulosic fraction of municipal solid waste (MSW), and refuse-derived fuel (RDF).

16. The conversion system of claim 10, wherein the carbonaceous material is selected from the group consisting of natural gas, shale gas, and methane.

17. The conversion system of claim 10, wherein the system is effective to produce a final synthesis gas product, the system further comprising:
a cyclone separator adapted to receive the synthesis gas and remove solid particulates from the synthesis gas to produce a second synthesis gas product;
a barrier filter adapted to receive the second synthesis gas product and remove entrained particulates from the second product to produce a third synthesis gas product;
a gas conditioning reactor adapted to receive the third synthesis gas product and facilitate a water-gas shift reaction on the third synthesis gas product to produce a fourth synthesis gas product;
a carbon dioxide scrubber adapted to receive the fourth synthesis gas product and remove carbon dioxide from the fourth synthesis gas product to produce a fifth synthesis gas product; and
a gas synthesis reactor adapted to receive the fifth synthesis gas product and chemically synthesize the fifth product into the final fuels and/or chemical products.

18. The conversion system of claim 17, wherein the carbon dioxide scrubber is further adapted to produce and feed recycled carbon dioxide to a heat exchanger, and the heat exchanger is adapted to receive the recycled carbon dioxide, receive heat output from the gas synthesis reactor, and provide heated carbon dioxide to the third source.

19. A reactor, comprising:
a housing;
a first feed port adapted to receive a biomass;
a second feed port adapted to separately receive carbonaceous material and carbon dioxide; and
a fluidized bed comprising fluidizing solids,
wherein the reactor contains gasified biomass, carbonaceous material dry reformed with carbon dioxide, fluidizing solids, and a synthesis gas.

20. The reactor of claim 19, wherein the fluidizing solid in the fluidized bed is adapted to maintain a bubbling fluidized bed.
